(19) United States
(12) Patent Application Publication
(10) Pub. No.: US 2025/0200715 A1
(43) Pub. Date: Jun. 19, 2025

(54) METHOD AND ELECTRONIC DEVICE FOR MOTION-BASED IMAGE ENHANCEMENT

(71) Applicant: SAMSUNG ELECTRONICS CO., LTD., Suwon-si (KR)

(72) Inventors: Bindigan Hariprasanna PAWAN PRASAD, Bangalore (IN); Green Rosh K S, Bangalore (IN); Vishakha S R, Bangalore (IN)

(73) Assignee: SAMSUNG ELECTRONICS CO., LTD., Suwon-si (KR)

(21) Appl. No.: 19/064,174

(22) Filed: Feb. 26, 2025

Related U.S. Application Data
(63) Continuation of application No. PCT/KR2023/012652, filed on Aug. 25, 2023.

(30) Foreign Application Priority Data
Aug. 26, 2022 (IN) 202241048869
Jul. 4, 2023 (IN) 202241048869

(51) Int. Cl. G06T 5/50; G06T 5/70; G06T 5/73; G06T 5/92; G06T 7/246

(52) U.S. Cl. CPC G06T 5/50; G06T 5/70; G06T 5/73; G06T 5/92; G06T 7/246; G06T 2207/20182; G06T 2207/20201; G06T 2207/20208; G06T 2207/20221; G06T 2207/30196

(57) ABSTRACT

A method for motion-based image enhancement is provided. The method may include receiving a plurality of image frame(s) including a subject(s) that performs an action(s). The method may include determining the plurality of key points associated with the subject(s) of the plurality of image frame(s) and detecting the action(s) performed by the subject(s) using the plurality of estimated key points. The method may include identifying a motion characteristic(s) associated with the plurality of estimated key points. The method may include identifying one or more regions in the plurality of image frame(s) to be enhanced based on the determined motion characteristic(s) with the plurality of estimated key points and the detected action(s). The method may include generating an enhanced image including the one or more enhanced regions compared to the one or more regions of the obtained image frame(s).

### CROSS-REFERENCE TO RELATED APPLICATION(S)

The present application is a bypass continuation application of International Application No. PCT/KR2023/012652, filed on Aug. 25, 2023, which is based on and claims priority from Indian Provisional Patent Application No. 202241048869, filed on Aug. 26, 2022, and Indian Complete Patent Application No. 202241048869, filed on Jul. 4, 2023, in the Indian Patent Office, the disclosures of which are herein incorporated by reference in their entireties.

### BACKGROUND

### 1. Field

One or more example embodiments of the disclosure relate to an electronic device, more specifically related to a method and an electronic device for motion-based image enhancement.

### 2. Description of Related Art

Image enhancement has recently gained widespread attention, particularly in consumer markets of smartphones. Leading smartphone vendors have recently made exceptional progress in image enhancement areas such as High Dynamic Range (HDR) and low light de-noising. However, image capturing of a moving subject such as a human often results in an artefact. FIG. 1 illustrates a problem in a related art image enhancement mechanism caused by presence of a moving subject, according to the prior art. Referring to FIG. 1, image capturing of a moving subject may result in an artefact such as blur, as illustrated in an image 1 as well as in the absence of a good lighting condition in an artefact such as low light noising, as illustrated in an image 2.

Image enhancement via artefact reduction is critical for both aesthetics and downstream computer vision tasks. Multi-frame algorithms such as Multi-Frame Noise Removal (MFNR) and the HDR are commonly used in image enhancement methods. To avoid the creation of artefacts such as blur as in the image 1, low light noising as in the image 2, and/or a ghost as in an image 3, during image processing, the multi-frame algorithms frequently compute motion maps. The motion maps are frequently computed using photometric difference-based methods or human key points-based methods. However, in the presence of blur, low light noising, and/or a ghost, these approaches frequently result in false positive motions. As a result, an output image has more noise as shown in the image 2 or a lower dynamic range as shown in an image 4.

The photometric difference-based methods use a photometric alignment (optionally for HDR) of each pixel followed by a photometric difference. In the presence of noise to generate the motion map, the motion map generation is prone to errors. As a result, large areas of false positive motion may be produced. The large areas of a false positive motion result in less blending of regions, which further results in a loss of dynamic range or an increase in noise, as illustrated in FIG. 2A and FIG. 2B that will be described in more detail below.

The human key points-based methods estimate human poses by computing human key points which are then analyzed to detect motion. In the presence of high noise and/or blur, the estimated human key points may be erroneous, which further leads to a classification of static regions as motion (false positive motion). Subsequently, this leads to the lower dynamic range as in the image 4 of FIG. 1 or higher noise as in the image 2 of FIG. 1.

Thus, it is desirable to address the above-mentioned disadvantages and/or other shortcomings and/or at least provide a useful alternative for motion-based image enhancement.

### SUMMARY

One or more example embodiments of the disclosure may intelligently generate an image by identifying one or more regions with image artefact(s) (e.g., a blur region, a region with a large amount of movement, etc.) from a plurality of regions in received image frame(s) or obtained image frame(s) to be enhanced based on a motion characteristic(s) associated with a plurality of estimated key points associated with a subject(s) of the received image frame(s) or obtained image frame(s) and an action(s) performed by the subject(s) using the plurality of estimated key points. As a result, the enhanced image may include one or more enhanced regions that are free of the image artefacts when compared to the one or more regions from the plurality of regions of the received image frame(s) or obtained image frame(s), which enhances user experience.

One or more example embodiments of the disclosure may determine an optimal motion map from a plurality of optimal image frames by predicting a local motion region(s) (e.g., user's leg) in the received image frame(s) or obtained image frame(s) based on the detected action(s) (e.g., user's jump) and the plurality of estimated key points, where the plurality of optimal image frames includes a peak action(s) (e.g., user's jump in air) of the detected action(s). The optimal motion map is utilized to generate the enhanced image (e.g. High Dynamic Range (HDR) image, de-noised image, blur-corrected image, reflection removed image, etc.).

According to an aspect of an example embodiment, there is provided a method for motion-based image enhancement, the method including: receiving, by an electronic device, a plurality of image frames including at least one subject that performs at least one action; estimating, by the electronic device, a plurality of key points associated with the at least one subject in the plurality of obtained image frames; detecting, by the electronic device, the at least one action performed by the at least one subject using the plurality of estimated key points; identifying, by the electronic device, at least one motion characteristic associated with the plurality of estimated key points; identifying, by the electronic device, one or more regions to be enhanced in at least one obtained image frame of the plurality of obtained image frames, based on the at least one identified motion characteristic associated with the plurality of estimated key points and the at least one detected action; and generating, by the electronic device, an enhanced image including one or more enhanced regions by applying at least one image enhancement to the identified one or more regions.

The identifying the one or more regions to be enhanced may include: determining, by the electronic device, an optimal motion map using a plurality of optimal image frames based on at least one predicted local motion region and the plurality of estimated key points; performing, by the electronic device, localization of a spatial-temporal artefact for the plurality of optimal image frames based on the determined optimal motion map, the at least one identified motion characteristic associated with the plurality of estimated key points, and the at least one detected action; and identifying, by the electronic device, the one or more regions to be enhanced in the at least one obtained image frame of the plurality of obtained image frames based on the localization of the spatial-temporal artefact, wherein the one or more regions include at least one image artefact.

The determining the optimal motion map may include: determining, by the electronic device, the plurality of optimal image frames from the plurality of obtained image frames based on the at least one detected action; predicting, by the electronic device, the at least one local motion region in at least one optimal image frame of the determined plurality of optimal image frames based on the at least one detected action; determining, by the electronic device, a digital skeleton using the plurality of estimated key points; and determining, by the electronic device, the optimal motion map using the plurality of optimal image frames based on the at least one predicted local motion region and the digital skeleton.

The generating the enhanced image may include generating at least one of a High Dynamic Range (HDR) image, a de-noised image, a blur corrected image, or a reflection removed image.

The generating the HDR image may include: clustering, by the electronic device, the identified one or more regions in the at least one obtained image frame and clustering the plurality of obtained image frames into a plurality of frame groups, respectively, based on the at least one identified motion characteristic associated with the plurality of estimated key points and the at least one detected action, wherein the plurality of frame groups includes a first frame group including frames having a lower displacement, a second frame group including frames having a medium displacement, and a third frame group including frames having a higher displacement; generating, by the electronic device, a high exposure frame using the frames in the first frame group; generating, by the electronic device, a medium exposure frame using the frames in the second frame group; generating, by the electronic device, a low exposure frame using the frames in the third frame group; and blending, by the electronic device, the generated high exposure frame, the generated medium exposure frame, and the generated low exposure frame to generate the HDR image.

The generating the de-noised image may include generating a motion map based on the at least one identified motion characteristic associated with the plurality of estimated key points.

The generating the blur corrected image may include: determining, by the electronic device, whether each of the at least one identified motion characteristic exceeds a pre-defined threshold; and generating, by the electronic device, the blur corrected image by applying a blur correction to one or more regions surrounding at least one key point of which a motion characteristic exceeds the pre-defined threshold.

The generating the reflection removed image may include: determining, by the electronic device, a correlation between at least one identified motion characteristic associated with the plurality of estimated key points of a first subject with at least one identified motion characteristic associated with the plurality of estimated key points of a second subject; classifying, by the electronic device, at least one highly correlated key point of the second subject as a reflection key point; generating, by the electronic device, a reflection map using the classified at least one highly correlated key point; and generating, by the electronic device, the reflection removed image using the generated reflection map.

The identifying the one or more regions to be enhanced may include: comparing, by the electronic device, at least one computed value of the at least one identified motion characteristic associated with the plurality of estimated key points with at least one expected value of the at least one identified motion characteristic associated with the plurality of estimated key points; determining, by the electronic device, a deviation of the at least one computed value corresponding to each of the plurality of estimated key points from the at least one expected value; and determining, by the electronic device, a first set of key points of the plurality of estimated key points having the deviation greater than a threshold value.

According to an aspect of an example embodiment, there is provided an electronic device for motion-based image enhancement, the electronic device including: a memory; a processor coupled to the memory; and an image processing controller, implemented by the processor, the image processing controller being configured to: obtain a plurality of image frames including at least one subject that performs at least one action; estimate a plurality of key points associated with the at least one subject in the plurality of obtained image frames; detect the at least one action performed by the at least one subject using the plurality of estimated key points; identify at least one motion characteristic associated with each of the plurality of estimated key points; identify one or more regions to be enhanced in at least one obtained image frame of the plurality of obtained image frames, based on the at least one identified motion characteristic associated with each of the plurality of estimated key points and the at least one detected action; and generate an enhanced image including one or more enhanced regions by applying at least one image enhancement to the identified one or more regions.

11. The electronic device of claim 10, wherein the image processing controller is further configured to: determine a pose of a subject in a scene being captured; identify the plurality of key points from the determined pose; measure a plurality of motion parameters for the plurality of key points, respectively; determine whether each of the plurality of measured motion parameters exceeds a pre-defined threshold; and apply a blur correction to regions surrounding at least one key point of which a measured motion parameter exceeds the pre-defined threshold.

12. The electronic device of claim 10, wherein the image processing controller is further configured to: determine an optimal motion map using a plurality of optimal image frames based on at least one predicted local motion region and the plurality of estimated key points; perform localization of a spatial-temporal artefact for the plurality of optimal image frames based on the determined optimal motion map, the at least one identified motion characteristic associated with the plurality of estimated key points, and the at least one detected action; and identify the one or more regions to be enhanced in the at least one obtained image frame of the plurality of obtained image frames based on the localization of the spatial-temporal artefact, wherein the one or more regions include at least one image artefact.

The image processing controller may be further configured to: determine the plurality of optimal image frames from the plurality of obtained image frames based on the at least one detected action; predict the at least one local motion region in at least one optimal image frame of the determined plurality of optimal image frames based on the at least one detected action; determine a digital skeleton using the plurality of estimated key points; and determine the optimal motion map using the plurality of optimal image frames based on the at least one predicted local motion region and the digital skeleton.

The image processing controller may be further configured to generate at least one of a High Dynamic Range (HDR) image, a de-noised image, a blur corrected image, or a reflection removed image.

The image processing controller may be further configured to: cluster the identified one or more regions in the at least one obtained image frame and cluster the plurality of obtained image frames into a plurality of frame groups, respectively, based on the at least one identified motion characteristic associated with the plurality of estimated key points and the at least one detected action, wherein the plurality of frame groups include a first frame group including frames having a lower displacement, a second frame group including frames having a medium displacement, and a third frame group including frames having a higher displacement; generate a high exposure frame using the frames in the first frame group; generate a medium exposure frame using the frames in the second frame group; generate a low exposure frame using the frames in the third frame group; and blend the generated high exposure frame, the generated medium exposure frame, and the generated low exposure frame to generate the HDR image.

According to an aspect of an example embodiment of the disclosure, provided is These and other aspects of the embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the embodiments herein, and the embodiments herein include all such modifications.

### BRIEF DESCRIPTION OF DRAWINGS

These and/or other aspects will become apparent and more readily appreciated from the following description of the example embodiments, taken in conjunction with the accompanying drawings, in which:

FIG. 1 illustrates a problem in a related art image enhancement mechanism caused by presence of a moving subject, according to the prior art;

FIG. 2A and FIG. 2B illustrate a problem in an existing High Dynamic Range (HDR) image enhancement mechanism, according to the prior art;

FIG. 3 illustrates a block diagram of an electronic device for motion-based image enhancement, according to an example embodiment;

FIG. 4 is a flow diagram illustrating a method for motion-based image enhancement, according to an example embodiment;

FIG. 5 is a system flow diagram illustrating a method for motion-based image enhancement, according to an example embodiment;

FIG. 6 illustrates various operations associated with an action-based artefact region localizer for motion-based image enhancement, according to an example embodiment;

FIG. 7 illustrates various operations associated with a peak action identifier and a local motion predictor for motion-based image enhancement, according to an example embodiment;

FIG. 8 illustrates various operations associated with a region identifier for motion localizer for the motion-based image enhancement, according to an example embodiment;

FIG. 9 illustrates various operations associated with a spatial-temporal artefacts localizer for the motion-based image enhancement, according to an example embodiment;

FIG. 10 illustrates various operations associated with an image enhancer to generate an HDR image, according to an example embodiment;

FIG. 11 is a flow diagram illustrating a method for generating a blur-corrected image using the image enhancer, according to an example embodiment;

FIG. 12 illustrates various operations associated with the image enhancer to generate a de-noised image, according to an example embodiment; and

FIG. 13A and FIG. 13B illustrate an example flow diagram of a method for motion-based image enhancement, according to an example embodiment.

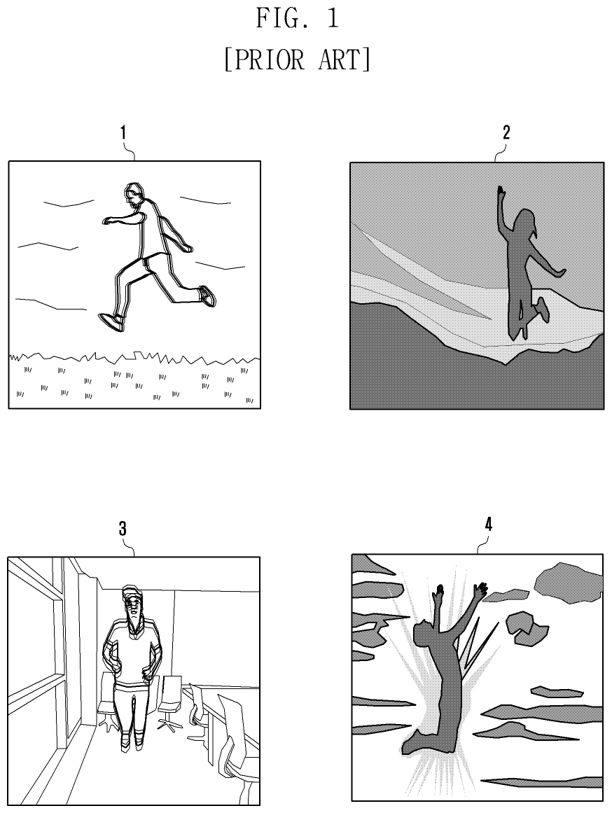

### DETAILED DESCRIPTION

Example embodiments of the disclosure and the various features and advantageous details thereof are explained more fully with reference to the non-limiting example embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments may be combined with one or more other embodiments to form new embodiments. The term “or” as used herein, refers to a non-exclusive or, unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

Example embodiments may be described and illustrated in terms of blocks which carry out a described function or functions. These blocks, which may be referred to herein as managers, units, modules, hardware components or the like, may be physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

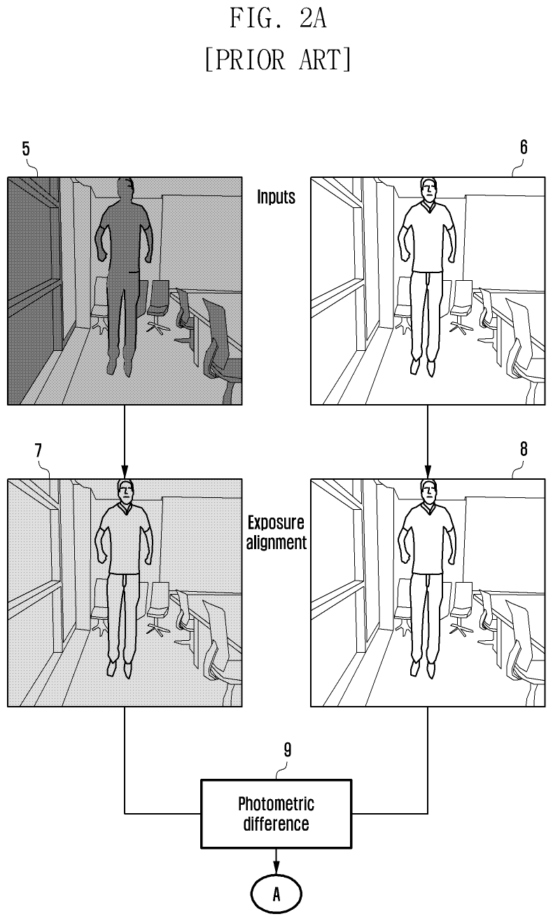

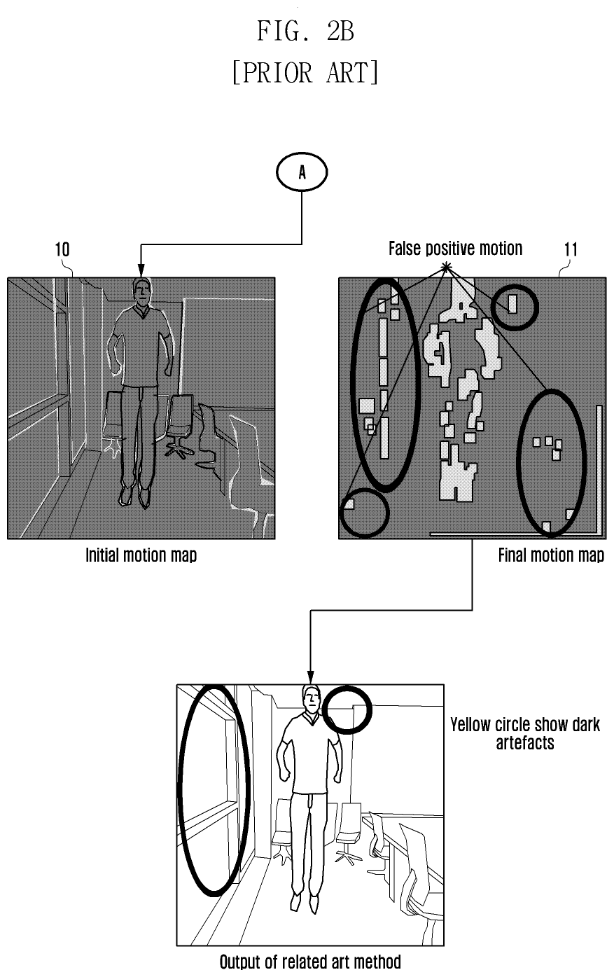

FIG. 2A and FIG. 2B illustrate a problem in an existing HDR image enhancement mechanism, according to the prior art.

Referring to FIGS. 2A and 2B, the existing HDR image enhancement mechanism receives or obtains a plurality of image frames 5 and 6 including a subject (e.g. human) performing an action(s) (e.g., jump). The existing HDR image enhancement mechanism then performs an exposure alignment 7 and 8 on the received or obtained plurality of image frames 5 and 6. The existing HDR image enhancement mechanism then determines a photometric difference of the image frames on which the exposure alignment 7 and 8 has been performed. The existing HDR image enhancement mechanism then generates an initial motion map 10. The generated initial motion map 10 is prone to errors. As a result, large areas of false positive motion are produced, as shown in 11. The large areas of the false positive result in less blending of these regions, resulting in a loss of dynamic range and/or an increase in noise and/or dark artefacts, which have a negative impact on user experience. A method for image enhancement according to an example embodiment of the disclosure resolves these problems by using action recognition to localize motion regions, thereby being resistant to the artefacts such as noise and blur.

Accordingly, an example embodiment of the disclosure provides a method for motion-based image enhancement. The method may include receiving, by the electronic device, an image frame(s) including a subject(s) performing an action(s). Further, the method may include determining (or estimating), by the electronic device, a plurality of key points associated with the subject(s) of the received image frame(s) or the obtained image frame(s). Further, the method may include detecting, by the electronic device, the action(s) performed by the subject(s) using the plurality of estimated key points. Further, the method may include identifying, by the electronic device, a motion characteristic(s) associated with the plurality of estimated key points. Further, the method may include identifying, by the electronic device, one or more regions to be enhanced from a plurality of regions in the received image frame(s) or the received image frame(s) based on the identified motion characteristic(s) with the plurality of estimated key points and the detected action(s). Further, the method may include generating, by the electronic device, an enhanced image including the one or more enhanced regions compared to the one or more regions from the plurality of regions of the received image frame(s) or the received image frame(s). Further, the method may include storing, by the electronic device, the enhanced image comprising the one or more enhanced regions of the plurality of regions.

Accordingly, an example embodiment of the disclosure provides the electronic device for motion-based image enhancement. The electronic device may include an image processing controller coupled with a processor and a memory. The image processing controller may receive or obtain the image frame(s) including the subject(s) performing the action(s). The image processing controller may determine (or estimate) the plurality of key points associated with the subject(s) of the received image frame(s) or the received image frame(s). The image processing controller may detect the action(s) performed by the subject(s) using the plurality of estimated key points. The image processing controller may identify the motion characteristic(s) associated with the plurality of estimated key points. The image processing controller may identify the one or more regions to be enhanced from the plurality of regions in the received image frame(s) or the received image frame(s) based on the identified motion characteristic(s) associated with the plurality of estimated key points and the detected action(s). The image processing controller may generate the enhanced image including the one or more enhanced regions compared to the one or more regions from the plurality of regions of the received image frame(s) or the received image frame(s). The image processing controller may store the enhanced image comprising the one or more enhanced regions of the plurality of regions.

Unlike existing methods and systems, in the method according to an example embodiment, the electronic device may intelligently generate the image by identifying one or more regions having image artefact(s) (e.g., a blur region, a region with a large amount of movement, etc.) and to be enhanced from a plurality of regions in received image frame(s) or the received image frame(s) based on the motion characteristic(s) associated with the plurality of estimated key points, wherein the subject(s) of the received image frame(s) or the received image frame(s) are associated with the action(s) performed by the subject(s) using the plurality of estimated key points. As a result, the enhanced image may include one or more enhanced regions that are free of the image artefacts when compared to the one or more regions from the plurality of regions of the received image frame(s) or the received image frame(s), which enhances user experience.

Unlike existing methods and systems, in the method according to an example embodiment, the electronic device may determine an optimal motion map for a plurality of optimal image frames by predicting a local motion region(s) (e.g., user's leg) in the received image frame(s) or the received image frame(s) based on the detected action(s) (e.g., user's jump) and the plurality of estimated key points, wherein the plurality of optimal image frames may include a peak action(s) (e.g., user's jump in air) of the detected action(s). The optimal motion map may be utilized to generate the enhanced image (e.g. HDR image, de-noised image, blur-corrected image, reflection removed image, etc.).

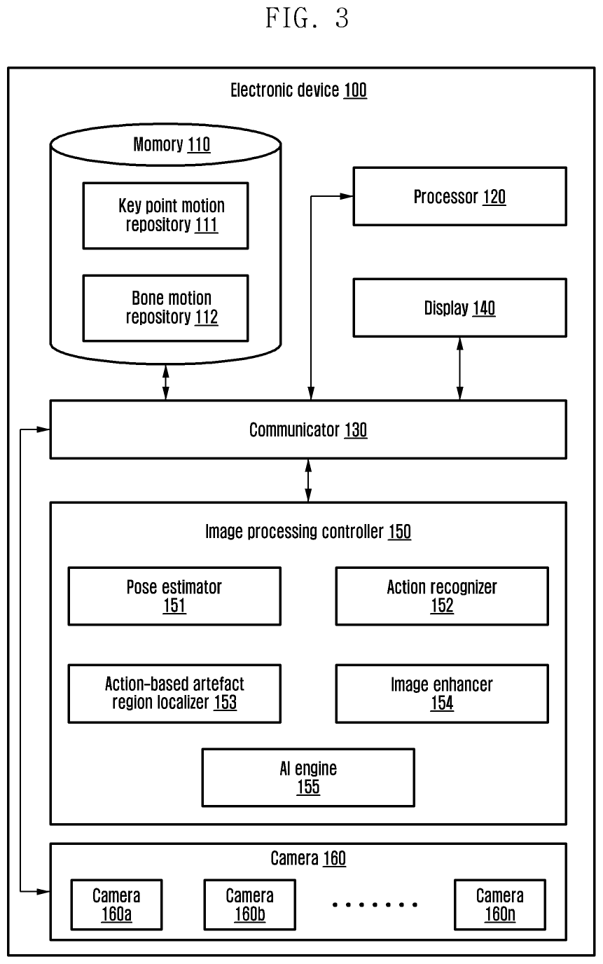

Referring now to the drawings and more particularly to FIGS. 3 through 13, example embodiments will be described where similar reference characters denote corresponding features consistently throughout the figures.

FIG. 3 illustrates a block diagram of an electronic device 100 for motion-based image enhancement, according to an example embodiment. The electronic device 100 may be, for example, but is not limited to a smart phone, a laptop, a desktop, a smart watch, a smart TV, an Augmented Reality device (AR device), a Virtual Reality (VR) device, Internet of Things (IoT) device or a like.

In an embodiment, the electronic device 100 may include a memory 110, a processor 120, a communicator 130, a display 140, an image processing controller 150, and a camera 160.

In an embodiment, the memory 110 may store a plurality of image frames including a subject(s), a plurality of key points associated with the subject(s) in a key point motion repository 111 of the memory 110, information associated with a bone motion in a bone motion repository 112 of the memory 110, an action(s) performed by the subject(s), a plurality of optimal image frames, an optimal motion map for the plurality of optimal image frames, one or more regions with image artefact(s), and an enhanced image(s) with one or more enhanced regions of the plurality of regions. The memory 110 may store instructions to be executed by the processor 120. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal only. However, the term “non-transitory” should not be interpreted that the memory 110 is non-movable. In some examples, the memory 110 may be configured to store larger amounts of information than the memory. In certain examples, a non-transitory storage medium may store data that may, over time, change (e.g., in Random Access Memory (RAM) or cache). The memory 110 may be an internal storage unit or may be an external storage unit of the electronic device 100, a cloud storage, or any other type of external storage.

The processor 120 may communicate with the memory 110, the communicator 130, the display 140, the image processing controller 150, and the camera 160. The camera 160 may include a primary camera 160a and a secondary camera (160b-160n) to capture the image frame(s). The processor 120 may be configured to execute instructions stored in the memory 110 and to perform various processes. The processor 120 may include one or a plurality of processors, maybe a general-purpose processor, such as a Central Processing Unit (CPU), an Application Processor (AP), or the like, a Graphics-only Processing Unit such as a graphics processing unit (GPU), a Visual Processing Unit (VPU), and/or an Artificial Intelligence (AI) dedicated processor such as a Neural Processing Unit (NPU).

The communicator 130 may be configured for communicating internally between internal hardware components and with external devices (e.g. server) via one or more networks (e.g. Radio technology). The communicator 130 may include an electronic circuit specific to a standard that enables wired or wireless communication.

The display 140 may include a Liquid Crystal Display (LCD), a Light Emitting Diode (LED), an Organic Light-Emitting Diode (OLED), or another type of display. The display 140 may receive or obtain a user input in a form of, for example, touch, swipe, drag, gesture, voice command, and other types of a user input.

The image processing controller 150 may be implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the image processing controller 150 may include a pose estimator 151, an action recognizer 152, an action-based artefact region localizer 153, an image enhancer 154, and an Artificial Intelligence (AI) engine 155.

The pose estimator 151 may receive or obtain the image frame(s) including the subject(s) (e.g., human, plant, animal, etc.) performing the action(s) (e.g., jump). The pose estimator 151 may determine the plurality of key points associated with the subject(s) of the received image frame(s) or the obtained image frame(s). The action recognizer 152 may detect the action(s) performed by the subject(s) using the plurality of estimated key points. The action recognizer 152 may identify a motion characteristic(s). The motion characteristic associated with the plurality of estimated key points may be for example but not limited to velocity, acceleration, displacement.

The action-based artefact region localizer 153 may identify one or more regions to be enhanced from a plurality of regions in the received image frame(s) or the received image frame(s) based on the identified motion characteristic(s) associated with the plurality of estimated key points and the detected action(s). The action-based artefact region localizer 153 may determine a plurality of optimal image frames from the received image frame(s) or the received image frame(s) based on the detected action(s). The plurality of optimal image frames may be image frames which include a peak action(s) of the detected action(s). The action-based artefact region localizer 153 may predict a local motion region(s) in the received image frame(s) or the received image frame(s) based on the detected action(s). The action-based artefact region localizer 153 may determine an optimal motion map for the plurality of optimal image frames based on the predicted local motion region(s) and the plurality of estimated key points. The action-based artefact region localizer 153 may perform localization of spatial-temporal artefacts for the plurality of optimal image frames based on the determined optimal motion map, the identified motion characteristic(s) associated with the plurality of estimated key points and the detected action(s). The localization of the spatial-temporal artefacts may refer to locating the spatial-temporal artefacts in a specific location within the optimal motion map. The action-based artefact region localizer 153 may identify the one or more regions to be enhanced from the plurality of regions in the received image frame(s) or the received image frame(s) based on the localization of spatial-temporal artefacts, where the one or more regions includes an image artefact(s), and the image artefact(s) includes, for example, a blur region, a noise region, a dark region, and a motion region.

The action-based artefact region localizer 153 may generate an initial motion map of the plurality of optimal image frames based on an image restoration mechanism. The action-based artefact region localizer 153 may generate a digital skeleton by connecting the plurality of estimated key points. The action-based artefact region localizer 153 may retrieve a motion probability of key points and bones of the generated digital skeleton from a pre-defined dictionary of a database (e.g., key point motion repository 111, bone motion repository 112, etc.) of the electronic device 100 for the detected action(s). The action-based artefact region localizer 153 may update the generated digital skeleton based on the retrieved motion probability of key points and bones. The action-based artefact region localizer 153 may determine the optimal motion map based on the predicted local motion region(s), the generated initial motion map, and the updated digital skeleton.

The action-based artefact region localizer 153 may determine a standard deviation of noise of the plurality of optimal image frames using a classical learning mechanism and a deep learning mechanism to identify one or more regions to be enhanced from the plurality of regions in the received image frame(s) or the received image frame(s). The action-based artefact region localizer 153 may determine at least one static region from the plurality of regions in the at least one received image frame or the received image frame(s). Further, the action-based artefact region localizer 153 may determine at least one variation key point in the at least one static region. In an action such as standing still, the key points are supposed to be static. However, due to an error in initial pose estimation, there may be variations in the key-points estimated. However, since these key points are supposed to be static, the variation and/or error expected in key point-estimation (or pose estimation) may be determined. Errors in pose estimation may be modelled as a Gaussian distribution. The mean and variance of the model may be estimated using the key point data in static regions. The action-based artefact region localizer 153 may determine a motion parameter(s) of each key point in the predicted local motion region(s) based on a post-estimation error and the plurality of estimated key points, where the motion parameter(s) may include a displacement, a velocity, an acceleration, etc. The action-based artefact region localizer 153 may determine a motion between subsequent frames of the plurality of optimal image frames using the determined motion parameter(s). The action-based artefact region localizer 153 may determine a size of blur-kernel based on the determined motion to identify the one or more regions to be enhanced from the plurality of regions in the received image frame(s) or the received image frame(s).

The image enhancer 154 may generate the enhanced image including the one or more enhanced regions compared to the one or more regions from the plurality of regions of the received image frame(s) or the received image frame(s). The image enhancer 154 may generate the enhanced image by applying an image enhancement mechanism that may include, for example, a High Dynamic Range (HDR) image, a de-noised image, a blur-corrected image, and a reflection-removed image.

The image enhancer 154 may cluster the identified one or more regions from the plurality of regions in the received or obtained image frame(s) and the received or obtained image frame(s) into a plurality of frame groups based on the identified motion characteristic(s) associated with the plurality of estimated key points and the detected action(s), where the plurality of frame groups may include frames having a lower displacement, a frames having a medium displacement, and frames having a higher displacement. The image enhancer 154 may generate a high exposure frame from the frames having the lower displacement. The image enhancer 154 may generate a medium exposure frame from the frames having the medium displacement. The image enhancer 154 may generate a low exposure frame from the frames having the higher displacement. The image enhancer 154 may blend the generated high exposure frame, the generated medium exposure frame, and the generated low exposure frame to generate the HDR image.

The image enhancer 154 may generate the de-noised image by utilizing the optimal motion map.

The image enhancer 154 may determine whether the motion parameter(s) exceeds a pre-defined threshold. The image enhancer 154 may apply blur correction to regions surrounding the key points whose measured motion parameters exceed the pre-defined threshold. The image enhancer 154 may generate the blur-corrected image by applying the blur correction to regions surrounding the key points whose measured motion parameters exceed the pre-defined threshold.

The image enhancer 154 may determine a correlation between the identified motion characteristic(s) associated with the plurality of estimated key points of a first subject with the identified motion characteristic(s) associated with the plurality of estimated key points of a second subject. The image enhancer 154 may classify a highly correlated key point(s) of the second subject as reflection key points. The image enhancer 154 may generate a reflection map using the classified highly correlated key point(s). The image enhancer 154 may generate the reflection-removed image using the generated reflection map.

In an embodiment, the image enhancer 154 may compare computed values of the one or more motion characteristics associated with each of the plurality of estimated key points with expected values, where the expected values are pre-computed. Further, the image enhancer 154 may determine a deviation of the computed values of the plurality of estimated key points from the expected values. Further, the image enhancer 154 may determine a first set of key points of the plurality of estimated key points having the deviation greater than a threshold value. The first set of key points may be initial key points computed using a known method.

A function associated with the AI engine 155 (or machine learning (ML) model) may be performed through the non-volatile memory, the volatile memory, and/or the processor 120. One or a plurality of processors may control processing of input data in accordance with a predefined operating rule or AI model stored in the non-volatile memory and/or the volatile memory. The predefined operating rule or AI model may be provided through training or learning. Here, being provided through learning means that, by applying a learning algorithm to a plurality of learning data, a predefined operating rule or AI engine 155 of a desired characteristic may be obtained. The learning may be performed in a device itself in which AI according to an embodiment is performed, and/or may be implemented through a separate server and/or system. The learning algorithm may be a method for training a predetermined target device (for example, a robot) using a plurality of learning data to cause, allow, or control the target device to decide or predict. Examples of learning algorithms may include, but are not limited to, supervised learning, unsupervised learning, semi-supervised learning, or reinforcement learning.

The AI engine 155 may include a plurality of neural network layers. Each layer may have a plurality of weight values and perform a layer operation through a calculation of a previous layer and an operation of a plurality of weights. Examples of neural networks may include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and Deep Q-Networks.

In an embodiment, the processor 120 may include the image processing controller 150.

In an embodiment, the image processing controller 150 may be configured to receive or obtain the image frame(s) including the subject(s) performing the action(s). The image processing controller 150 may be configured to determine the plurality of key points associated with the subject(s) of the received image frame(s) or the received image frame(s). The image processing controller 150 may be configured to detect the action(s) performed by the subject(s) using the plurality of estimated key points. The image processing controller 150 may be configured to identify the motion characteristic(s) associated with the plurality of estimated key points. The image processing controller 150 may be configured to identify the one or more regions to be enhanced from the plurality of regions in the received image frame(s) or the received image frame(s) based on the identified motion characteristic(s) associated with the plurality of estimated key points and the detected action(s). The image processing controller 150 may be configured to generate the enhanced image including the one or more enhanced regions compared to the one or more regions from the plurality of regions of the received image frame(s) or the received image frame(s). The image processing controller 150 may be configured to store the enhanced image including the one or more enhanced regions of the plurality of regions.

In an embodiment, the image processing controller 150 may be configured to receive or obtain the image frame(s) including the subject(s) performing the action(s). The image processing controller 150 may be configured to estimate a pose of the subject(s) (e.g., human body) by using the AI engine 155 (deep neural network). The subject(s) may include of the plurality of key points (e.g., k approximated key points) for each part of the subject(s) (e.g., head, wrist, etc.). As the received or obtained image frame(s) may be corrupted due to blur, noise, and other factors, the plurality of key points generated by the pose estimator 151 may only be approximated. The image processing controller 150 may be configured to detect the action(s) (e.g., jumps, squats, throws, etc.) performed by the subject(s) using the plurality of estimated key points by using the AI engine 155 and generate an action label(s) corresponding to the detected action(s).

In an embodiment, the image processing controller 150 may be configured to determine a type of image artefact(s) and strength of the one or more regions (e.g., M regions) to be enhanced from the plurality of regions in the optimal image frame(s) (e.g., N image frames) based on the action label(s), the plurality of key points, and the received or obtained image frame(s). The image processing controller 150 may be configured to identify the motion characteristic(s) associated with the plurality of estimated key points, to identify the one or more regions to be enhanced from the plurality of regions in the received image frame(s) or the received image frame(s) based on the identified motion characteristic(s) with the plurality of estimated key points and the detected action(s) (e.g., a set of N image frames with M regions of artefacts and a (1×M) vector denoting the strength of each of these artefacts (or motion contained)), and to generate the enhanced image (e.g., best frame) including the one or more enhanced regions compared to the one or more regions from the plurality of regions of the received image frame(s) or the received image frame(s). The image processing controller 150 may be configured to minimize the artefacts (or image artefact(s)) and generate the enhanced image by utilizing a combination of the received image frame(s) or the received image frame(s).

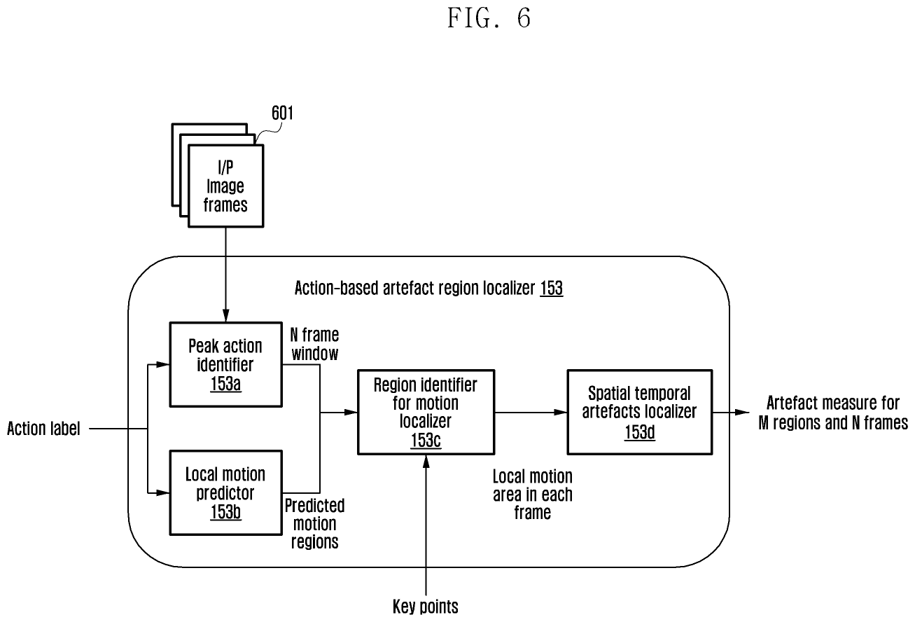

In an embodiment, the image processing controller 150 may be configured to determine the plurality of optimal image frames (e.g., N image frames) from the received or obtained image frame(s) (e.g., 601 in FIG. 6) based on the detected action(s) (or action label(s)), where the plurality of optimal image frames includes the peak action(s) of the detected action(s). The image processing controller 150 may be configured to identify a peak action(s) and/or peak frame for corresponding detected action(s). In a jump action, for example, the peak frame may correspond to a highest point reached by the jump action. In a javelin throw action, for example, the peak frame may correspond to a moment when a javelin leaves a hand of the subject. Because of the peak action(s) and/or peak frame(s) identification, a total processing time to generate the enhanced image may be reduced, according to an example embodiment of the disclosure. If the peak action is not identified, computation needs to be performed for every set of k frames (e.g., k is predefined) to identify one or more regions to be enhanced, whereas in an example embodiment, computation needs to be done only once to identify one or more regions to be enhanced.

The image processing controller 150 may be configured to predict the local motion region(s) in the received or obtained image frame(s) based on the detected action(s). The image processing controller 150 may be configured to predict a region including a large motion for the detected action(s) using a pre-defined look-up table. For example, limbs in the jump action may be predicted as the local motion region. The image processing controller 150 may be configured to determine the optimal motion map (e.g., (x, y) coordinates of the regions around each key point) in the plurality of optimal image frames (e.g., N image frames) based on the predicted local motion region(s) and the plurality of estimated key points (e.g., set of key points with probable motion).

The image processing controller 150 may be configured to perform the localization of spatial-temporal artefacts for the plurality of optimal image frames based on the determined optimal motion map, the identified motion characteristic(s) associated with the plurality of estimated key points and the detected action(s) and to identify the one or more regions to be enhanced from the plurality of regions in the received or obtained image frame(s) based on the localization of spatial-temporal artefacts.

The image processing controller 150 may be configured to determine whether the one or more regions (e.g., M regions and N image frames) are corrupted by some artefact (e.g., image artefact) such as noise and/or blur. The image processing controller 150 may be configured to return (or determine) a strength and/or a counter value and/or a counter action associated with the artefact in response to determining that the one or more regions are corrupted by some artefact(s). For example, when the image processing controller 150 detects that one or more regions are corrupted by the artefact (e.g., blur region), the image processing controller 150 may be configured to return a kernel size representing the strength of the blur. In another example, when the image processing controller 150 may be configured to detect that one or more regions are corrupted by the artefact (e.g., noise), the image processing controller 150 may be configured to return a standard deviation of the noise.

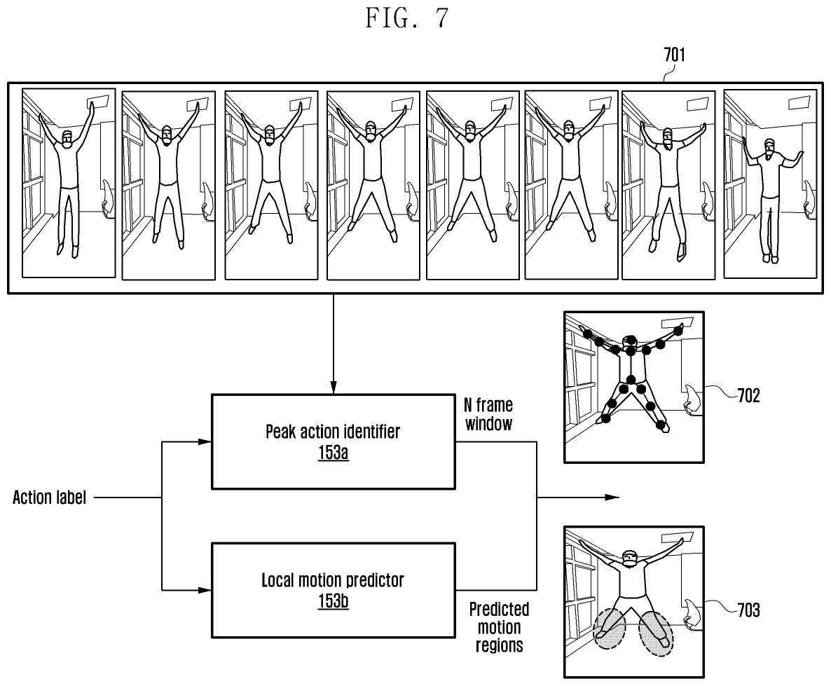

The image processing controller 150 may be configured to receive or obtain the image frame(s) (e.g., 701 in FIG. 7) including the subject(s) performing the action(s). The image processing controller 150 may be configured to identify a peak action(s)/a peak frame(s) (e.g., 702 in FIG. 7) from the received or obtained image frame(s) 701 for corresponding detected action(s) based on the action label(s). In the jump action, for example, the peak frame(s) 702 may correspond to a highest point reached by the jump action. The image processing controller 150 may be configured to predict the local motion region(s) (e.g., 703 in FIG. 7) in the received or obtained image frame(s) 701 based on the detected action(s). The local motion region(s) 703 may include a large motion (e.g., motion associated with legs) for the detected action(s) using the pre-defined look-up table.

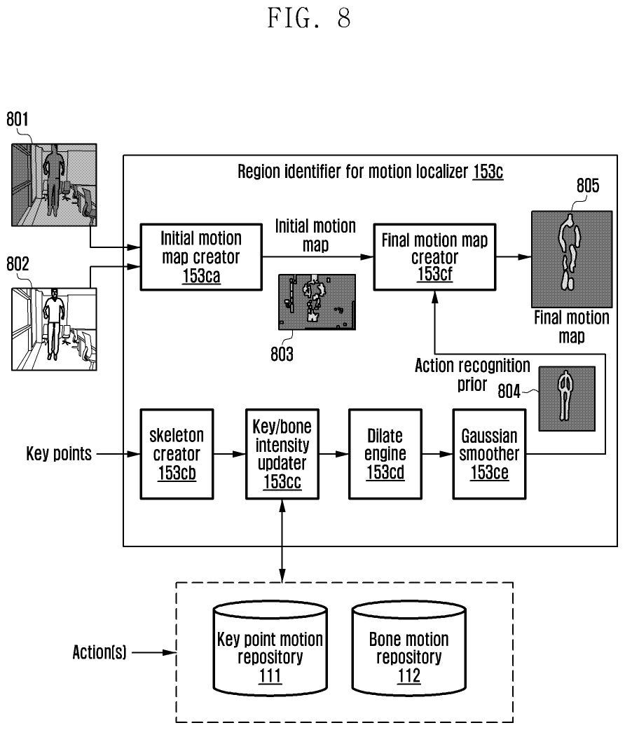

The image processing controller 150 may be configured to generate the initial motion map of the plurality of optimal image frames (e.g., 801 and 802 in FIG. 8) based on the image restoration mechanism (e.g., HDR/motion de-blurring). The image processing controller 150 may be configured to generate the digital skeleton by connecting the plurality of estimated key points. The image processing controller 150 may be configured to retrieve the motion probability of key points and bones of the generated digital skeleton from the pre-defined dictionary of the database (e.g., key point motion repository 111 and bone motion repository 112) of the electronic device 100 for the detected action(s). The motion probability/values of key points and bones may be chosen from a pre-computed Look-Up Table (LUT) for each action.

The image processing controller 150 may be configured to update the generated digital skeleton based on the retrieved motion probability of key points and bones. The image processing controller 150 may be configured to perform a dilation process on the updated digital skeleton. The image processing controller 150 may be configured to perform a smoothing process on a dilated digital skeleton 804. The image processing controller 150 may be configured to determine an optimal motion map 805 based on the predicted local motion region and/or the motion probability, the generated initial motion map and the updated and/or dilated and/or smoothed digital skeleton 804. The image processing controller 150 may be configured to be generated by combining values of the initial motion map and the motion probability.

The image processing controller 150 may be configured to detect that one or more regions are corrupted by the artefact (e.g., noise) in the plurality of optimal image frames (e.g., N image frames). The image processing controller 150 may then determine the standard deviation of noise of the plurality of optimal image frames using the classical learning mechanism and the deep learning mechanism. The image processing controller 150 may then return the strength and/or counter value and/or counter action associated with the artefact in response to determining that the one or more regions is corrupted by some artefact (e.g., noise).

The image processing controller 150 may be configured to determine the motion parameter(s) (e.g., a displacement, a velocity, and/or an acceleration) of each key point in the predicted local motion region(s) based on the post-estimation error and the plurality of estimated key points. The image processing controller 150 may be configured to determine the post-estimation error by analyzing a variation of key points in a static region(s) in the plurality of optimal image frames. In a previous stage, the image processing controller 150 may obtain an estimate of low and/or no motion region(s), which may be used to determine the post estimation error.

The image processing controller 150 may be configured to determine the motion between subsequent frames of the plurality of optimal image frames using the determined motion parameter(s). The image processing controller 150 may then determine the size of blur-kernel based on the determined motion to identify the one or more regions to be enhanced from the plurality of regions in the received image frame(s) or the received image frame(s). The image processing controller 150 may then obtain the strength and/or counter value and/or counteraction associated with the artefact in response to determining that the one or more regions are corrupted by some artefact (e.g., blur).

The image processing controller 150 may be configured to cluster the identified one or more regions from the plurality of regions in the received or obtained image frame(s) and the received or obtained image frame(s) into a plurality of frame groups based on the identified motion characteristic(s) associated with the plurality of estimated key points and detected action(s). The plurality of frame groups may include frames K1 having a lower displacement, frames K2 having a medium displacement, and frames K3 having a higher displacement. A relationship among displacements between the frames K1, K2, and K3 may be “displacement of frames K1<displacement of frames K2<displacement of frames K3”.

The image processing controller 150 may be configured to generate a high exposure frame K4 from the frames K3 having the lower displacement. The image processing controller 150 may be configured to generate a medium exposure frame K5 from the frames K2 having the medium displacement. The image processing controller 150 may be configured to generate a low exposure frame K6 from the frames K1 having the higher displacement. The frames K4, K5, and K6 may be added using a weighted addition of all the frames. The weighted addition may be performed using the motion map to remove ghosts while blending.

The image processing controller 150 may be configured to blend the generated high exposure frame K4, the generated medium exposure frame K5, and the generated low exposure frame K6 to generate the HDR image (1002). High, low and medium exposure images and/or frames may be created by blending frames on the displacement of key points, to reduce ghosting and achieve a high dynamic range. A lower number of frames (e.g., frames K3) having a large displacement may be blended to create low exposure frames (e.g., frame K6) and vice-versa.

The image processing controller 150 may be configured to receive or obtain the N image frames and information associated with the artefact measured for the M regions and the N image frames. The image processing controller 150 may be configured to determine an average blur in each image frame based on a present blur region(s). The image processing controller 150 may be configured to sort image frames in an ascending order of the average blur. The image processing controller 150 may be configured to store the sorted image frames in the memory 110. The image processing controller 150 may be configured to retrieve one or more image frames from the sorted image frames. The image processing controller 150 may be configured to determine a maximum blur from the retrieved one or more image frames. The image processing controller 150 may be configured to determine whether the maximum blur is less than a pre-defined threshold (t). If the maximum blur is less than the pre-set threshold (t), the image enhancer 154 may return the best frame (e.g., i^{th} frame). Otherwise, the sorted image frames 1104-1105 list may be checked until this constraint is met.

The image processing controller 150 may be configured to generate a motion map based on estimated displacement upon receiving the N image frames and the image artefact (e.g., motion) measured for the M regions in the N image frames. The image processing controller 150 represents regions where the motion of the subject(s) is detected. The motion map is typically a greyscale image with values ranging from 0 to 255. The higher a value, a higher confidence of a motion in that region. The motion map is generated using artefact measurements for the N image frames.

The image processing controller 150 may be configured to compensate for multi-frame motion noise reduction upon receiving the motion map and generate the de-noised image. The image processing controller 150 may be configured to use the motion map to blend the N image frames together using a weighted addition. While blending, regions with more motion are given less weightage.

The image processing controller 150 may be configured to receive or obtain the image frame(s) including the subject(s) performing the action(s). The image processing controller 150 may be configured to perform the exposure alignment on the received or obtained image frame(s) and generating the initial motion map. The image processing controller 150 may be configured to determine the plurality of key points (human pose/digital skeleton) associated with the subject(s) of the received image frame(s) or the received image frame(s). The image processing controller 150 may be configured to update the determined digital skeleton based on the retrieved motion probability of key points and bones. The image processing controller 150 may be configured to generate an intermediate motion map based on the generated initial motion map. The image processing controller 150 may be configured to generate the optimal/final motion map based on the intermediate motion map and the updated digital skeleton/the plurality of key points, the optimal/final motion map is generated by combining values of the initial motion map and the motion probability.

Although the FIG. 3 shows various hardware components of the electronic device 100 but it is to be understood that other embodiments are not limited thereon. In other embodiments, the electronic device 100 may include less or more number of components. Further, the labels or names of the components are used only for illustrative purpose and does not limit the scope of the disclosure. One or more components may be combined to perform the same or substantially similar functions for the motion-based image enhancement.

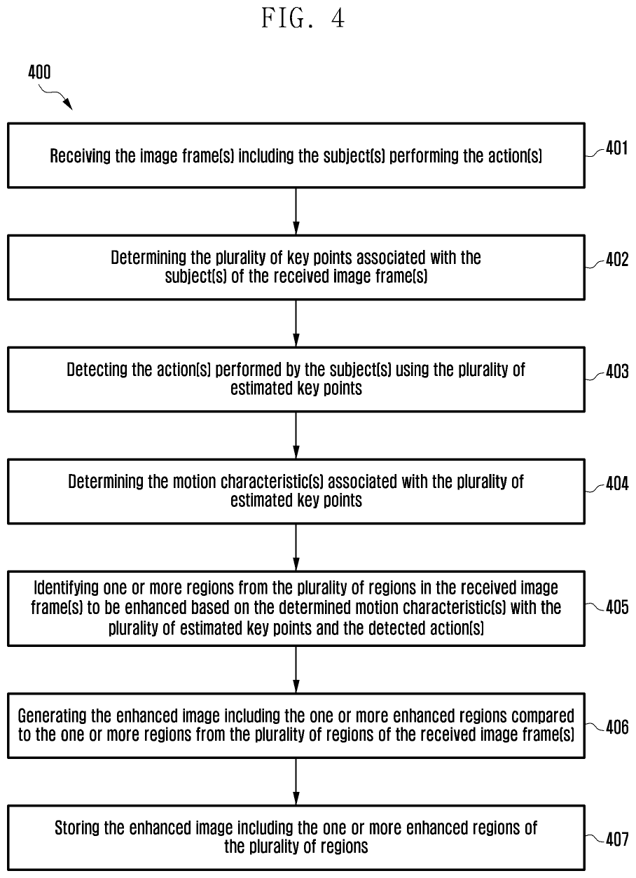

FIG. 4 is a flow diagram 400 illustrating a method for the motion-based image enhancement, according to an example embodiment. The electronic device 100 may perform various operations for the motion-based image enhancement.

At 401, the method may include receiving the image frame(s) including the subject(s) performing the action(s). At 402, the method may include determining the plurality of key points associated with the subject(s) of the received image frame(s) or the received image frame(s). At 403, the method may include detecting the action(s) performed by the subject(s) using the plurality of estimated key points. At 404, the method may include identifying the motion characteristic(s) associated with the plurality of estimated key points. At 405, the method may include identifying the one or more regions to be enhanced from the plurality of regions in the received or obtained image frame(s) based on the identified motion characteristic(s) associated with the plurality of estimated key points and the detected action(s). At 406, the method may include generating the enhanced image including the one or more enhanced regions compared to the one or more regions from the plurality of regions of the received image frame(s) or the received image frame(s). At 407, the method may include storing the enhanced image including the one or more enhanced regions of the plurality of regions.

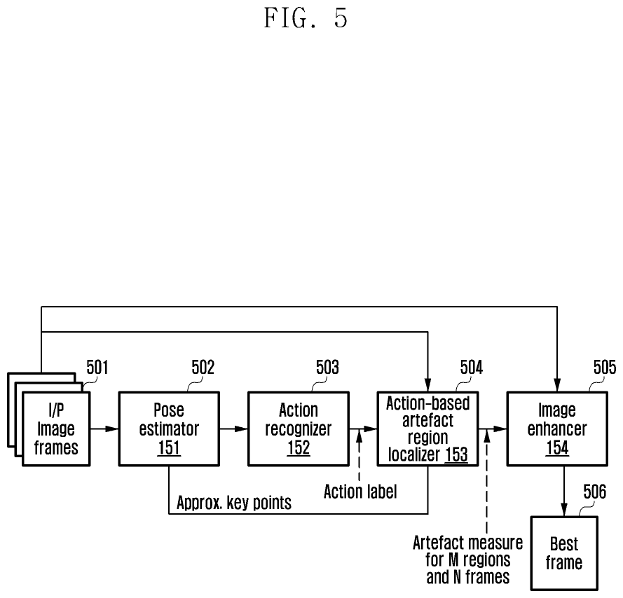

FIG. 5 is a system flow diagram illustrating the method for the motion-based image enhancement, according to an example embodiment.

At 501-502, the pose estimator 151 may receive or obtain the image frame(s) including the subject(s) performing the action(s). The pose estimator 151 may estimate a pose of the subject(s) (e.g., human body) by using the AI engine 155 (e.g., deep neural network). The subject(s) may include of the plurality of key points (e.g., k approximated key points) for each part of the subject(s) (e.g., head, wrist, etc.). As the received or obtained image frame(s) may be corrupted due to blur, noise, and/or other factors, the plurality of key points generated by the pose estimator 151 may only be approximated. At 503, the action recognizer 152 may detect the action(s) (e.g., jumps, squats, throws, etc.) performed by the subject(s) using the plurality of estimated key points by using the AI engine 155 and generate an action label(s) corresponding to the detected action(s).

At 504, the action-based artefact region localizer 153 may determine a type of image artefact(s) and strength of the one or more regions (e.g., M regions) to be enhanced from the plurality of regions in the optimal image frame(s) (e.g., N image frames) based on the action label(s), the plurality of key points, and the received image frame(s) or the received image frame(s). FIG. 6 shows additional information about the action-based artefact region localizer 153. At 505-506, the image enhancer 154 may identify the motion characteristic(s) associated with the plurality of estimated key points, identifies the one or more regions to be enhanced from the plurality of regions in the received or obtained image frame(s) based on the identified motion characteristic(s) with the plurality of estimated key points and the detected action(s) (e.g., a set of N image frames with M regions of artefacts and a (1×M) vector denoting the strength of each of these artefacts (or motion contained)), and generate the enhanced image (or best frame) including the one or more enhanced regions compared to the one or more regions from the plurality of regions of the received image frame(s) or the received image frame(s). The image enhancer 154 may minimize the artefacts (image artefact(s)) and generate the enhanced image by utilizing a combination of the received image frame(s) or the received image frame(s).

FIG. 6 illustrates various operations associated with the action-based artefact region localizer 153 for the motion-based image enhancement, according to an example embodiment.

In an embodiment, the action-based artefact region localizer 153 may include a peak action identifier 153a, a local motion predictor 153b, a region identifier for motion localizer 153c, and a spatial temporal artefacts localizer 153d.

The peak action identifier 153a may determine the plurality of optimal image frames (e.g., N image frames) from the received or obtained image frame(s) 601 based on the detected action(s) (or action label(s)), where the plurality of optimal image frames includes the peak action(s) of the detected action(s). The peak action identifier 153a may identify a peak action(s) and/or peak frame for corresponding detected action(s). In a jump action, for example, the peak frame may correspond to a highest point reached by the jump action. In a javelin throw action, for example, the peak frame may correspond to a moment when a javelin leaves a hand of the subject. Because of the peak action(s)/peak frame(s) identification, a total processing time to generate the enhanced image may be reduced, according to an example embodiment. If the peak action is not identified, computation needs to be performed for every set of k frames (e.g., k is predefined), whereas in the example embodiment, computation needs to be done only once.

The local motion predictor 153b may predict the local motion region(s) in the received or obtained image frame(s) based on the detected action(s). The local motion region(s) may include a large motion for the detected action(s) using a pre-defined look-up table. For example, limbs in the jump action may be predicted as the local motion region. The region identifier for motion localizer 153c may determine the optimal motion map (e.g., (x, y) coordinates of the regions around each key point) in the plurality of optimal image frames (e.g., N image frames) based on the predicted local motion region(s) and the plurality of estimated key points (e.g., set of key points with a probable motion).

The spatial-temporal artefacts localizer 153d may perform the localization of spatial-temporal artefacts for the plurality of optimal image frames based on the determined optimal motion map, the identified motion characteristic(s) associated with the plurality of estimated key points and the detected action(s) and identify the one or more regions to be enhanced from the plurality of regions in the received or obtained image frame(s) based on the localization of spatial-temporal artefacts.

The spatial-temporal artefacts localizer 153d may determine whether the one or more regions (e.g., M regions and N image frames) are corrupted by some artefact (e.g., image artefact) such as noise and/or blur. The spatial-temporal artefacts localizer 153d may return a strength and/or counter value and/or counter action associated with the artefact in response to determining that the one or more regions are corrupted by some artefact. For example, when the spatial-temporal artefacts localizer 153d detects that one or more regions are corrupted by the artefact (e.g., blur region), the spatial-temporal artefacts localizer 153d may return a kernel size representing the strength of the blur. In another example, when the spatial-temporal artefacts localizer 153d detects that one or more regions are corrupted by the artefact (e.g., noise), the spatial-temporal artefacts localizer 153d may return a standard deviation of the noise.

FIG. 7 illustrates various operations associated with the peak action identifier 153a and the local motion predictor 153b for the motion-based image enhancement, according to an example embodiment.

The peak action identifier 153a may receive or obtain the image frame(s) 701 including the subject(s) performing the action(s). The peak action identifier 153a may identify the peak action(s)/the peak frame(s) 702 from the received or obtained image frame(s) 701 for corresponding detected action(s) based on the action label(s). In the jump action, for example, the peak frame(s) 702 may correspond to a highest point reached by the jump action. The local motion predictor 153b may predict the local motion region(s) 703 in the received or obtained image frame(s) 701 based on the detected action(s). The local motion region(s) 703 may include a large motion (e.g., motion associated with legs) for the detected action(s) using the pre-defined look-up table.

FIG. 8 illustrates various operations associated with the region identifier for the motion localizer 153c for the motion-based image enhancement, according to an example embodiment.

The region identifier for motion localizer 153c may include an initial motion map creator 153ca, a digital skeleton creator 153cb, a key/bone intensity updater 153cc, a dilate engine 153cd, a Gaussian smoother 153ce, and a final motion map creator 153cf.

The initial motion map creator 153ca may generate an initial motion map 803 of the plurality of optimal image frames 801 and 802 based on the image restoration mechanism (e.g., HDR and/or motion de-blurring). The digital skeleton creator 153cb may generate the digital skeleton by connecting the plurality of estimated key points. The key/bone intensity updater 153cc may retrieve the motion probability of key points and bones of the generated digital skeleton from the pre-defined dictionary of the database (e.g., key point motion repository 111 and bone motion repository 112) of the electronic device 100 for the detected action(s). The motion probability/values of key points and bones may be chosen from a pre-computed Look-Up Table (LUT) for each action.

The key/bone intensity updater 153cc may update the generated digital skeleton based on the retrieved motion probability of key points and bones. The dilate engine 153cd may perform a dilation process on the updated digital skeleton. The Gaussian smoother 153ce may perform a smoothing process on the dilated digital skeleton 804. The final motion map creator 153cf may determine the optimal motion map 805 based on the predicted local motion region and/or the motion probability, the generated initial motion map and the updated and/or dilated and/or smoothed digital skeleton 804. The final motion map creator 153cf may generate the optimal motion map 805 by combining values of the initial motion map 803 and the motion probability.

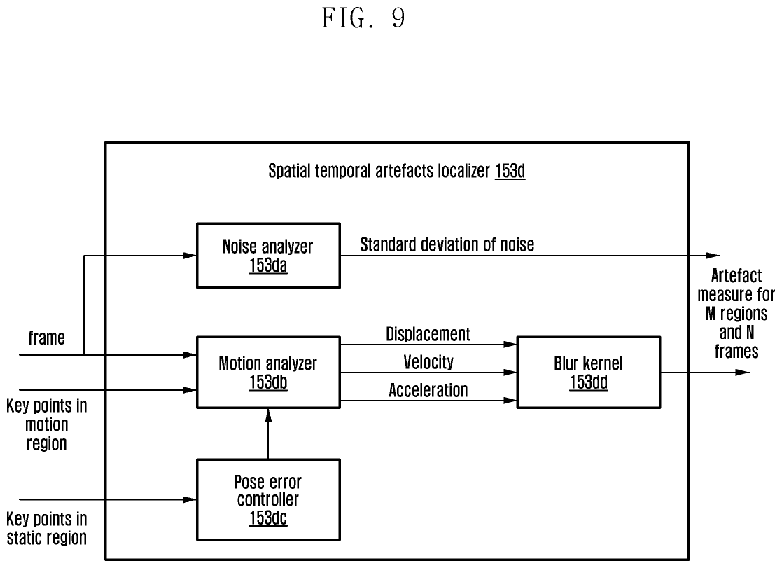

FIG. 9 illustrates various operations associated with the spatial-temporal artefacts localizer 153d for the motion-based image enhancement, according to an example embodiment. The spatial-temporal artefacts localizer 153d may include a noise analyzer 153da, a motion analyzer 153db, a pose controller 153dc, and a blur kernel 153dd.

The noise analyzer 153da may detect that one or more regions are corrupted by the artefact (e.g., noise) in the plurality of optimal image frames (e.g., N image frames). The noise analyzer 153da may then determine the standard deviation of noise of the plurality of optimal image frames using the classical learning mechanism and the deep learning mechanism. The noise analyzer 153da may then return the strength and/or counter value and/or counter action associated with the artefact to the image enhancer 154 in response to determining that the one or more regions is corrupted by some artefact (e.g., noise).

The motion analyzer 153db may determine the motion parameter(s) (e.g., a displacement, a velocity, and/or an acceleration) of each key point in the predicted local motion region(s) based on the post-estimation error and the plurality of estimated key points. The pose controller 153dc may determine the post-estimation error by analyzing a variation of key points in a static region(s) in the plurality of optimal image frames. In a previous stage, the motion analyzer 153db may obtain an estimate of a low and/or no motion region(s), which may be used to determine the post estimation error.

The blur kernel 153dd may determine the motion between subsequent frames of the plurality of optimal image frames using the determined motion parameter(s). The blur kernel 153dd may then determine the size of blur-kernel based on the determined motion to identify the one or more regions to be enhanced from the plurality of regions in the received or obtained image frame(s). The blur kernel 153dd may then return the strength and/or counter value and/or counteraction associated with the artefact to the image enhancer 154 in response to determining that the one or more regions are corrupted by some artefact (e.g., blur).

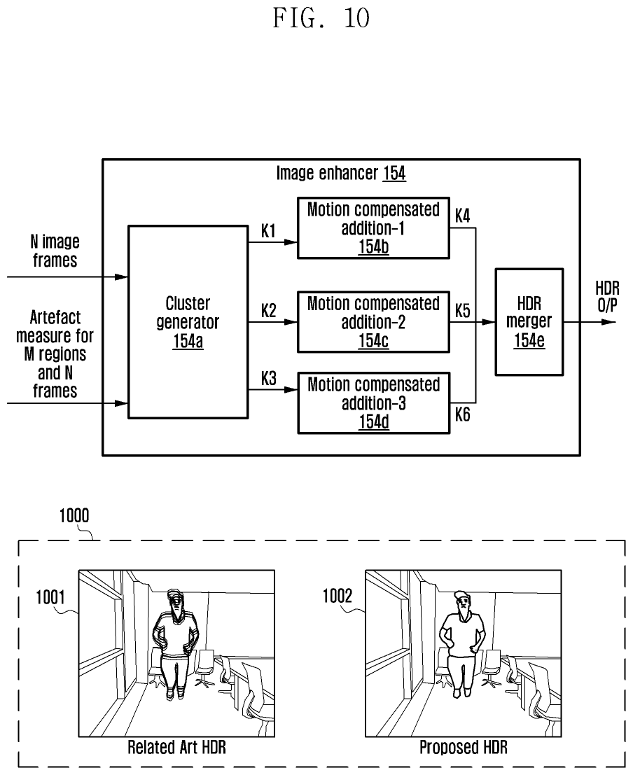

FIG. 10 illustrates various operations associated with the image enhancer 154 to generate the HDR image, according to an example embodiment. The image enhancer 154 may include a cluster generator 154a, a motion compensated addition-1 154b, a motion compensated addition-2 154c, a motion compensated addition-3 154d, and a HDR merger 154e.

The cluster generator 154a may cluster the identified one or more regions from the plurality of regions in the received or obtained image frame(s) and the received or obtained image frame(s) into a plurality of frame groups based on the identified motion characteristic(s) associated with the plurality of estimated key points and detected action(s). The plurality of frame groups may include the frames K1 having the lower displacement, the frames K2 having the medium displacement, and the frames K3 having the higher displacement. The relationship among displacements between the frames K1, K2, and K3 may be “displacement of frames K1<displacement of frames K2<displacement of frames K3”.

The cluster generator 154a may generate the high exposure frame K4 from the frames having the lower displacement. The cluster generator 154a may generate the medium exposure frame K5 from the frames having the medium displacement. The cluster generator 154a may generate the low exposure frame K6 from the frames having the higher displacement. The frames K4, K5, and K6 may be added using a weighted addition of all the frames. The weighted addition may be performed using the motion map to remove ghosts while blending.

The HDR merger 154e may blend the generated high exposure frame K4, the generated medium exposure frame K5) and the generated low exposure frame K6 to generate the HDR image 1002. High, low and medium exposure images and/or frames may be created by blending frames on the displacement of key points, to reduce ghosting and achieve a high dynamic range. A lower number of frames (e.g., frames K3) having a larger displacement may be blended to create low exposure frames (e.g., frame K6) and vice-versa. A comparison 1000 between a related art HDR image 1001 and a proposed HDR image 1002 according to an example embodiment is illustrated in FIG. 10. In comparison to the related art HDR image 1001, the proposed HDR 1002 has no ghosting effect/image artefact.

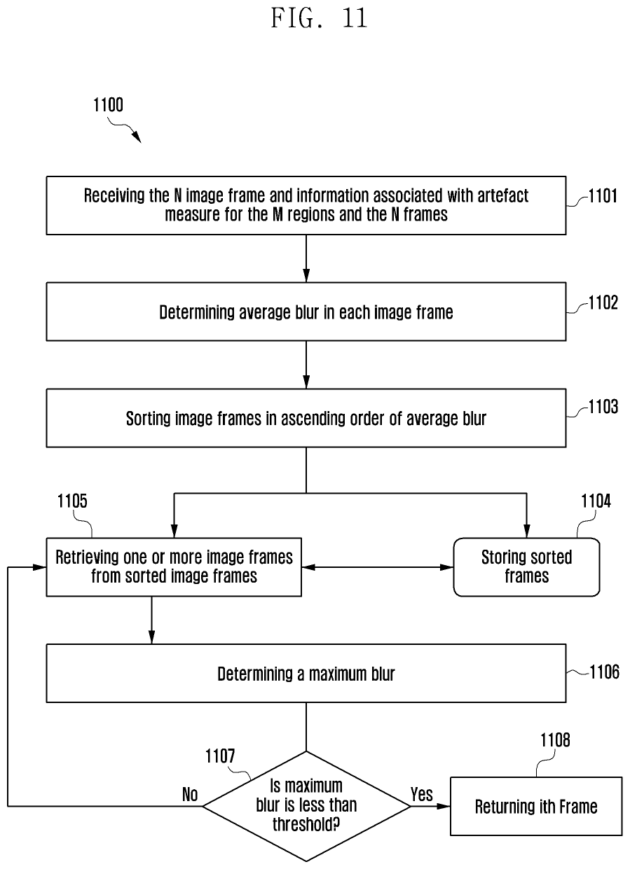

FIG. 11 is a flow diagram 1100 illustrating a method for generating the blur-corrected image using the image enhancer 154, according to an example embodiment.

At 1101, the method may include receiving the N image frames and information associated with the artefact measured for the M regions and the N image frames. At 1102, the method may include determining an average blur in each image frame based on a present blur region(s). At 1103, the method may include sorting image frames in an ascending order of the average blur. At 1104, the method may include storing the sorted image frames in the memory 110. At 1105, the method may include retrieving one or more image frames from the sorted image frames. At 1106, the method may include determining a maximum blur from the retrieved one or more image frames. At 1107-1108, the method may include determining whether the maximum blur is less than a pre-defined threshold (t). If the maximum blur is less than the pre-set threshold (t), the image enhancer 154 may return the best frame (e.g., i^{th} frame). Otherwise, the sorted image frame 1104-1105 list is checked until this constraint is met.

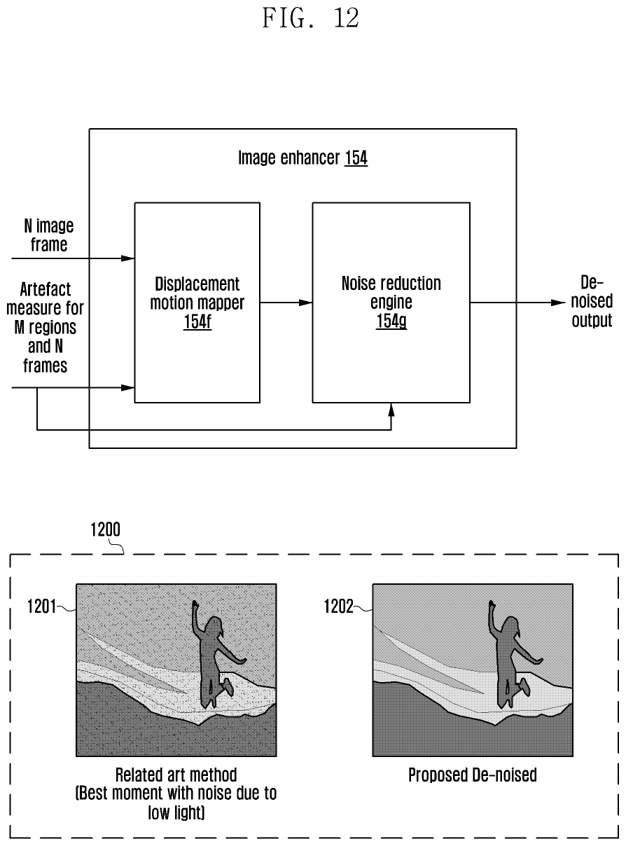

FIG. 12 illustrates various operations associated with the image enhancer 154 to generate a de-noised image, according to an example embodiment. The image enhancer 154 includes a displacement motion mapper 154f and a noise reduction engine 154g.

The displacement motion mapper 154f may generate a motion map based on estimated displacement upon receiving the N image frames and the image artefact (e.g., motion) measured for the M regions in the N image frames. The motion map may represent regions where the motion of the subject(s) is detected. The motion map is typically a greyscale image with values ranging from 0 to 255. The higher a value in the motion map is, a higher confidence of a motion in that region is. The motion map may be generated using artefact measurements for the N image frames.

The noise reduction engine 154g may compensate for multi-frame motion noise reduction upon receiving the motion map and generate the de-noised image. The noise reduction engine 154g may use the motion map to blend the N image frames together using a weighted addition. While blending, regions with more motion may be given less weightage. This ensures that there is no ghosting or blurring in the final output (or de-noised image). Furthermore, the noise may be greatly reduced in regions where there is no motion. A comparison 1200 between a related art de-noised image 1201 and a proposed de-noised image 1202 according to an example embodiment is illustrated in FIG. 12. In comparison to the related art de-noised image 1201, the proposed de-noised image 1202 has no noise effect and/or image artefact.

The photometric difference between the images is used in related art motion map generation method(s). Due to the presence of high noise, this may result in large regions with false positive motion regions. As a result, the final output 1201 in the related art method is noisy. On the other hand, the method according to an example embodiment may detect motion regions accurately, and frames with minimal motion may be chosen for motion-compensated noise reduction, as shown in 1202.

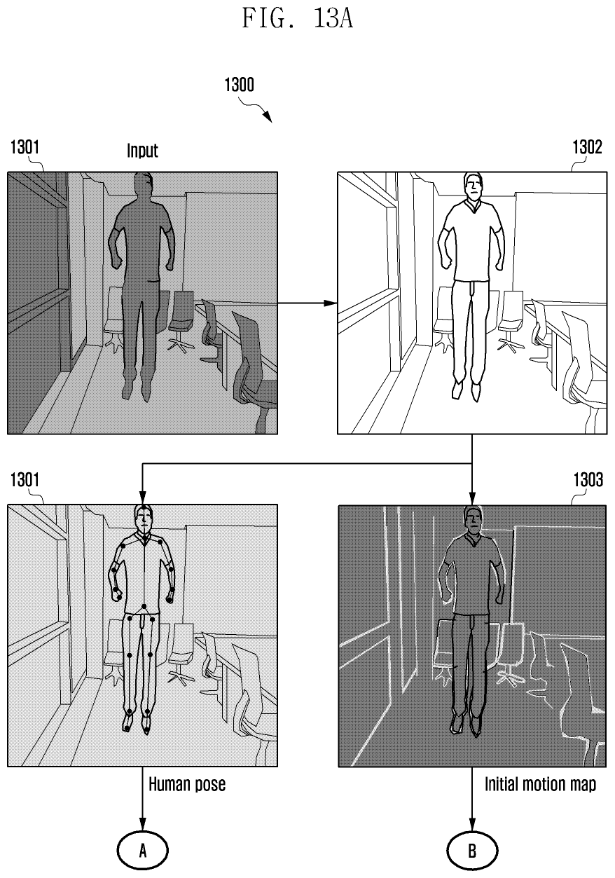

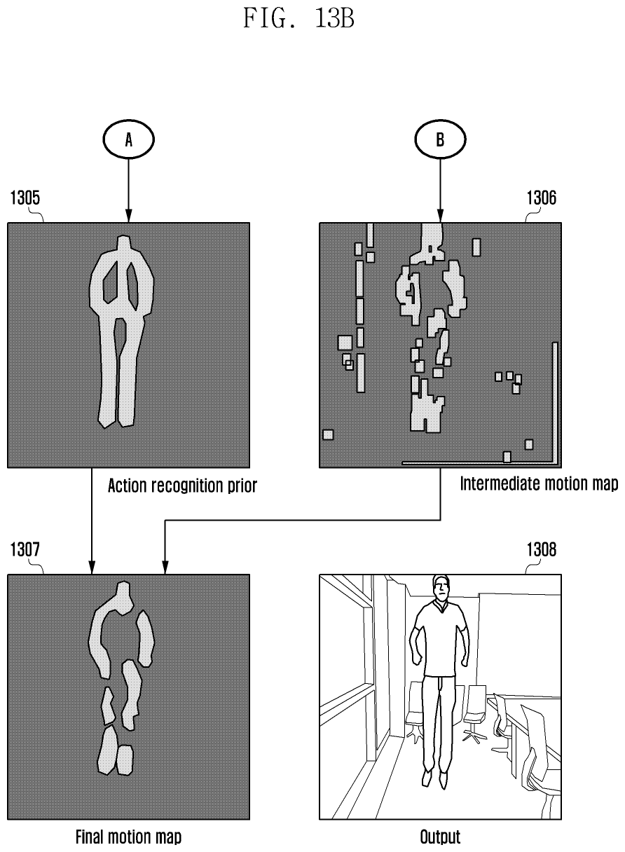

FIG. 13A and FIG. 13B illustrate an example flow diagram 1300 of a method for the motion-based image enhancement, according to an example embodiment. The electronic device 100 may perform various operations for the motion-based image enhancement.

At 1301, the method may include receiving the image frame(s) including the subject(s) performing the action(s). At 1302-1303, the method may include performing the exposure alignment on the received or obtained image frame(s) and generating the initial motion map. At 1304, the method may include determining the plurality of key points (e.g., human pose and/or digital skeleton) associated with the subject(s) of the received or obtained image frame(s). At 1305, the method may include updating the determined digital skeleton based on the retrieved motion probability of key points and bones. At 1306, the method may include generating an intermediate motion map based on the generated initial motion map. At 1307-1308, the method may include generating the optimal and/or final motion map based on the intermediate motion map, the updated digital skeleton, and/or the plurality of key points, and the optimal/final motion map may be generated by combining values of the initial motion map and the motion probability.

The various actions, acts, blocks, steps, or the like in the flow diagram (e.g., 400, 1100, and 1300) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein may be implemented using at least one hardware device and performing network management functions to control the elements.

The foregoing description of the example embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of example embodiments, those skilled in the art will recognize that the embodiments herein may be practiced with modification within the scope of the embodiments as described herein.

What is claimed is:

1. A method for motion-based image enhancement, the method comprising:
obtaining, by an electronic device, a plurality of image frames comprising at least one subject that performs at least one action;
estimating, by the electronic device, a plurality of key points associated with the at least one subject in the plurality of obtained image frames;
detecting, by the electronic device, the at least one action performed by the at least one subject using the plurality of estimated key points;
identifying, by the electronic device, at least one motion characteristic associated with the plurality of estimated key points;
identifying, by the electronic device, one or more regions to be enhanced in at least one obtained image frame of the plurality of obtained image frames, based on the at least one identified motion characteristic associated with the plurality of estimated key points and the at least one detected action; and
generating, by the electronic device, an enhanced image by enhancing the identified one or more regions.

2. The method of claim 1, wherein the identifying the one or more regions to be enhanced comprises:
determining, by the electronic device, an optimal motion map using a plurality of optimal image frames based on at least one predicted local motion region and the plurality of estimated key points;
performing, by the electronic device, localization of a spatial-temporal artefact for the plurality of optimal image frames based on the determined optimal motion map, the at least one identified motion characteristic associated with the plurality of estimated key points, and the at least one detected action; and
identifying, by the electronic device, the one or more regions to be enhanced in the at least one obtained image frame of the plurality of obtained image frames based on the localization of the spatial-temporal artefact, wherein the one or more regions comprise at least one image artefact.

3. The method of claim 2, wherein the determining the optimal motion map comprises:
determining, by the electronic device, the plurality of optimal image frames from the plurality of obtained image frames based on the at least one detected action;
predicting, by the electronic device, the at least one local motion region in at least one optimal image frame of the determined plurality of optimal image frames based on the at least one detected action;
determining, by the electronic device, a digital skeleton using the plurality of estimated key points; and
determining, by the electronic device, the optimal motion map using the plurality of optimal image frames based on the at least one predicted local motion region and the digital skeleton.

4. The method of claim 1, wherein the generating the enhanced image comprises generating at least one of a High Dynamic Range (HDR) image, a de-noised image, a blur corrected image, or a reflection removed image.

5. The method of claim 4, wherein the generating the HDR image comprises:
clustering, by the electronic device, the identified one or more regions in the at least one obtained image frame and clustering the plurality of obtained image frames into a plurality of frame groups, respectively, based on the at least one identified motion characteristic associated with the plurality of estimated key points and the at least one detected action, wherein the plurality of frame groups comprise a first frame group including frames having a lower displacement, a second frame group including frames having a medium displacement, and a third frame group including frames having a higher displacement;
generating, by the electronic device, a high exposure frame using the frames in the first frame group;
generating, by the electronic device, a medium exposure frame using the frames in the second frame group;
generating, by the electronic device, a low exposure frame using the frames in the third frame group; and
blending, by the electronic device, the generated high exposure frame, the generated medium exposure frame, and the generated low exposure frame to generate the HDR image.

6. The method of claim 4, wherein the generating the de-noised image comprises generating a motion map based on the at least one identified motion characteristic associated with the plurality of estimated key points.

7. The method of claim 4, wherein the generating the blur corrected image comprises:
determining, by the electronic device, whether each of the at least one identified motion characteristic exceeds a pre-defined threshold; and
generating, by the electronic device, the blur corrected image by applying a blur correction to one or more regions surrounding at least one key point of which a motion characteristic exceeds the pre-defined threshold.

8. The method of claim 4, wherein the generating the reflection removed image comprises:
determining, by the electronic device, a correlation between at least one identified motion characteristic associated with the plurality of estimated key points of a first subject with at least one identified motion characteristic associated with the plurality of estimated key points of a second subject;
classifying, by the electronic device, at least one highly correlated key point of the second subject as a reflection key point;
generating, by the electronic device, a reflection map using the classified at least one highly correlated key point; and
generating, by the electronic device, the reflection removed image using the generated reflection map.

9. The method of claim 1, wherein the identifying the one or more regions to be enhanced comprises:
comparing, by the electronic device, at least one computed value of the at least one identified motion characteristic associated with the plurality of estimated key points with at least one expected value of the at least one identified motion characteristic associated with the plurality of estimated key points;
determining, by the electronic device, a deviation of the at least one computed value corresponding to each of the plurality of estimated key points from the at least one expected value; and
determining, by the electronic device, a first set of key points of the plurality of estimated key points having the deviation greater than a threshold value.

10. An electronic device for motion-based image enhancement, the electronic device comprising:
a memory;
a processor coupled to the memory; and
an image processing controller, implemented by the processor, the image processing controller being configured to:
obtain a plurality of image frames comprising at least one subject that performs at least one action;
estimate a plurality of key points associated with the at least one subject in the plurality of obtained image frames;
detect the at least one action performed by the at least one subject using the plurality of estimated key points;
identify at least one motion characteristic associated with each of the plurality of estimated key points;
identify one or more regions to be enhanced in at least one obtained image frame of the plurality of obtained image frames, based on the at least one identified motion characteristic associated with each of the plurality of estimated key points and the at least one detected action; and
generate an enhanced image by enhancing the identified one or more regions.

11. The electronic device of claim 10, wherein the image processing controller is further configured to:
determine a pose of a subject in a scene being captured;
identify the plurality of key points from the determined pose;
measure a plurality of motion parameters for the plurality of key points, respectively;
determine whether each of the plurality of measured motion parameters exceeds a pre-defined threshold; and
apply a blur correction to regions surrounding at least one key point of which a measured motion parameter exceeds the pre-defined threshold.

12. The electronic device of claim 10, wherein the image processing controller is further configured to:
determine an optimal motion map using a plurality of optimal image frames based on at least one predicted local motion region and the plurality of estimated key points;
perform localization of a spatial-temporal artefact for the plurality of optimal image frames based on the determined optimal motion map, the at least one identified motion characteristic associated with the plurality of estimated key points, and the at least one detected action; and
identify the one or more regions to be enhanced in the at least one obtained image frame of the plurality of obtained image frames based on the localization of the spatial-temporal artefact, wherein the one or more regions comprise at least one image artefact.

13. The electronic device of claim 12, wherein the image processing controller is further configured to:
determine the plurality of optimal image frames from the plurality of obtained image frames based on the at least one detected action;
predict the at least one local motion region in at least one optimal image frame of the determined plurality of optimal image frames based on the at least one detected action;
determine a digital skeleton using the plurality of estimated key points; and
determine the optimal motion map using the plurality of optimal image frames based on the at least one predicted local motion region and the digital skeleton.

14. The electronic device of claim 10, wherein the image processing controller is further configured to generate at least one of a High Dynamic Range (HDR) image, a de-noised image, a blur corrected image, or a reflection removed image.

15. The electronic device of claim 14, wherein the image processing controller is further configured to:
cluster the identified one or more regions in the at least one obtained image frame and cluster the plurality of obtained image frames into a plurality of frame groups, respectively, based on the at least one identified motion characteristic associated with the plurality of estimated key points and the at least one detected action, wherein the plurality of frame groups comprises a first frame group including frames having a lower displacement, a second frame group including frames having a medium displacement, and a third frame group including frames having a higher displacement;
generate a high exposure frame using the frames in the first frame group;
generate a medium exposure frame using the frames in the second frame group;
generate a low exposure frame using the frames in the third frame group; and
blend the generated high exposure frame, the generated medium exposure frame, and the generated low exposure frame to generate the HDR image.
